(19) United States
(12) Patent Application Publication
(10) Pub. No.: US 2020/0269791 A1
(43) Pub. Date: Aug. 27, 2020

(54) EXTERNAL AIRBAG SAFETY SYSTEM

(71) Applicant: Andrew Rhoden, Philadelphia, PA (US)

(72) Inventor: Andrew Rhoden, Philadelphia, PA (US)

(21) Appl. No.: 16/585,258

(22) Filed: Sep. 27, 2019

Related U.S. Application Data
(60) Provisional application No. 62/809,968, filed on Feb. 25, 2019.

(51) Int. Cl. B60R 21/013

(52) U.S. Cl. CPC B60R 21/013; B60R 2021/009

(57) ABSTRACT

An external airbag safety system is provided. The airbag safety system embodied in the present invention is adapted to inflate externally around a vehicle or structure to lessen the impact of a collision. Each external airbag may be urged from a deflated stowed condition to an inflated deployed condition immediately prior the collision sensed by one or more of the sensors. In the stowed condition, the boundaries of the external airbags are mutually inclusive of the boundary of the associated vehicle or structure, while in the deployed condition the inflated airbag forms a shock-absorbing shape protruding operatively beyond the boundary of the associated vehicle or structure, thereby lessening the total destruction wrought from the imminent collision.

### CROSS-REFERENCE TO RELATED APPLICATION

This application claims the benefit of priority of U.S. provisional application No. 62/809,968, filed 25 Feb. 2019, the contents of which are herein incorporated by reference.

### BACKGROUND OF THE INVENTION

The present invention relates to external airbag safety systems and, more particularly, to an airbag system adapted to inflate externally around a vehicle or structure to lessen the impact of a collision, thereby lessening the total destruction wrought from such tragedies.

The tragedy of 9/11 ended thousands of human lives through the destruction of buildings by way of employing aircrafts as missiles. But what if there was an external airbag safety system adaptable for both the aircrafts and the buildings—hundreds of lives may have saved that day—and the next time.

As can be seen, there is a need for an airbag system adapted to inflate externally around a vehicle or structure to lessen the impact of a collision, thereby lessening the impact of a collision.

### SUMMARY OF THE INVENTION

In one aspect of the present invention, an external airbag safety system for vehicles including the following: one or more stowable inflatable airbags movable between a stowed condition and a deployed condition; each stowable inflatable airbag defined by a stowed boundary; each stowable inflatable airbag attached to a vehicle so that the stowed boundary is mutually inclusive relative a vehicular boundary of the vehicle; the deployed condition comprises a rectangular deployed shape disposed beyond the vehicular boundary; one or more sensor operatively associated with each stowable inflatable airbags, wherein each sensor is configured to urge each stowable inflatable airbag to the deployed condition when sensing an imminent collision of the vehicle, wherein the deployed shape is rectangular having a rectangular height of the rectangular deployed shape is approximately coextensive with a height of a portion the vehicle to which the stowable inflatable airbag is attached. By “approximately” the term means zero to twenty-four inches, either above or below, said height.

In another aspect of the present invention, an external airbag safety system for a building structure includes the following: one or more stowable inflatable airbags movable between a stowed condition and a deployed condition; each stowable inflatable airbag defined by a stowed boundary; each stowable inflatable airbag attached to a vehicle so that the stowed boundary is mutually inclusive relative a structural boundary of the building structure; and the deployed condition comprises a deployed shape disposed beyond the structural boundary. In certain embodiments, a retractable roof of the building structure provides a spring support operatively associated with each corner of the retractable roof; and at least one of the one or more stowable inflatable airbag is attached to at least one corner of the retractable roof.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention embodied in a car;

FIG. 2 is a side view of an exemplary embodiment of the present invention, demonstrating deployment with the car;

FIG. 3 is a perspective view of an exemplary embodiment of the present invention embodied in a truck;

FIG. 4 is a side view of an exemplary embodiment of the present invention, demonstrating deployment with the truck;

FIG. 5 is a perspective view of an exemplary embodiment of the present invention embodied in a bus;

FIG. 6 is a side view of an exemplary embodiment of the present invention, demonstrating deployment with the bus;

FIG. 7 is a perspective view of an exemplary embodiment of the present invention embodied in an aircraft;

FIG. 8 is a top view of an exemplary embodiment of the present invention, demonstrating deployment with the aircraft;

FIG. 9 is a perspective view of an exemplary embodiment of the present invention embodied in a nose of the aircraft;

FIG. 10 is a side view of an exemplary embodiment of the present invention, demonstrating deployment with the nose of the aircraft;

FIG. 11 is a perspective view of an exemplary embodiment of the present invention embodied along top and bottom portions of the aircraft;

FIG. 12 is a side view of an exemplary embodiment of the present invention, demonstrating deployment with the top and bottom portions of the aircraft;

FIG. 13 is a side view of an exemplary embodiment of the present invention embodied in a train;

FIG. 14 is a side view of an exemplary embodiment of the present invention, demonstrating deployment with the train;

FIG. 15 is a side view of an exemplary embodiment of the present invention embodied in a watercraft;

FIG. 16 is a side view of an exemplary embodiment of the present invention, demonstrating deployment with the watercraft;

FIG. 17 is a side view of an exemplary embodiment of the present invention embodied in a building; and

FIG. 18 is a side view of an exemplary embodiment of the present invention, demonstrating deployment with the building.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an external airbag safety system adapted to inflate externally around a vehicle or structure to lessen the impact of a collision. Each external airbag may be urged from a deflated stowed condition to an inflated deployed condition immediately prior to the collision. In the stowed condition, the boundaries of the external airbags are mutually inclusive of the boundary of the associated vehicle or structure, while in the deployed condition the inflated deployed condition forms a shock-absorbing shape protruding operatively beyond the boundary of the associated vehicle or structure, thereby lessening the total destruction wrought from the imminent collision.

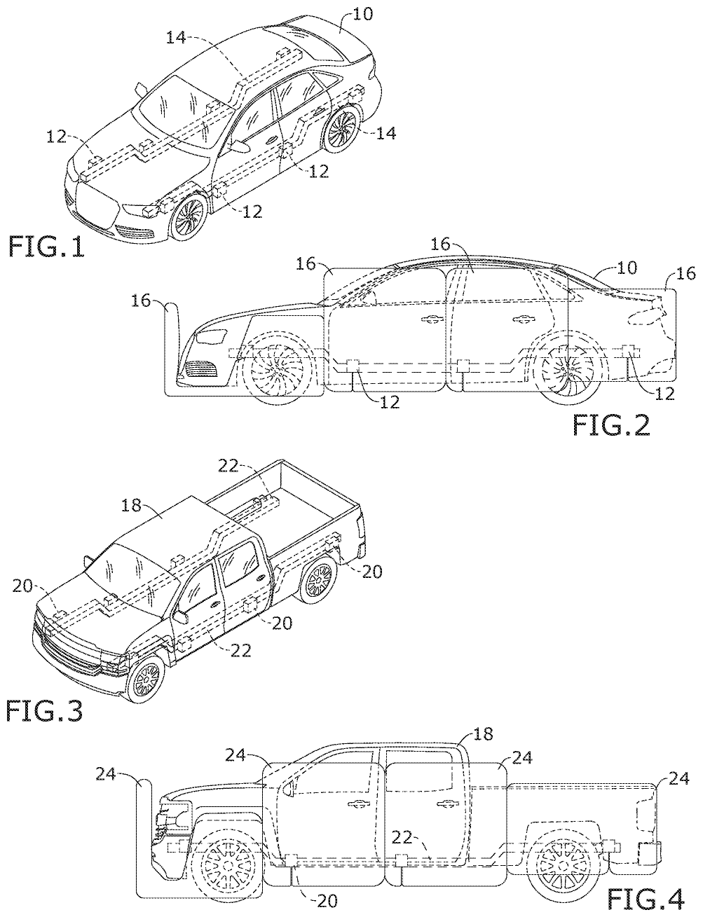

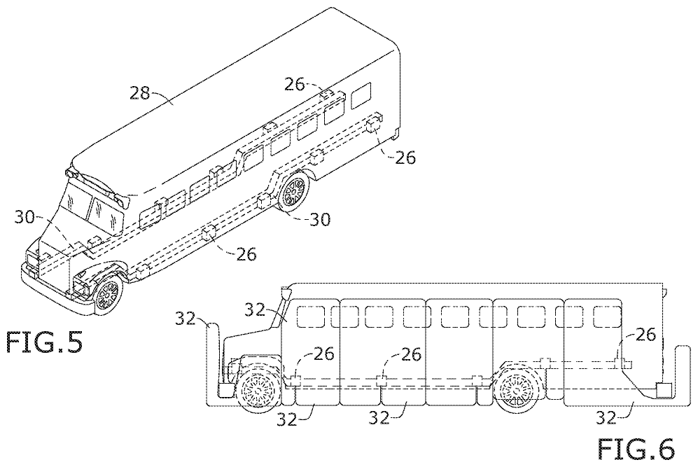

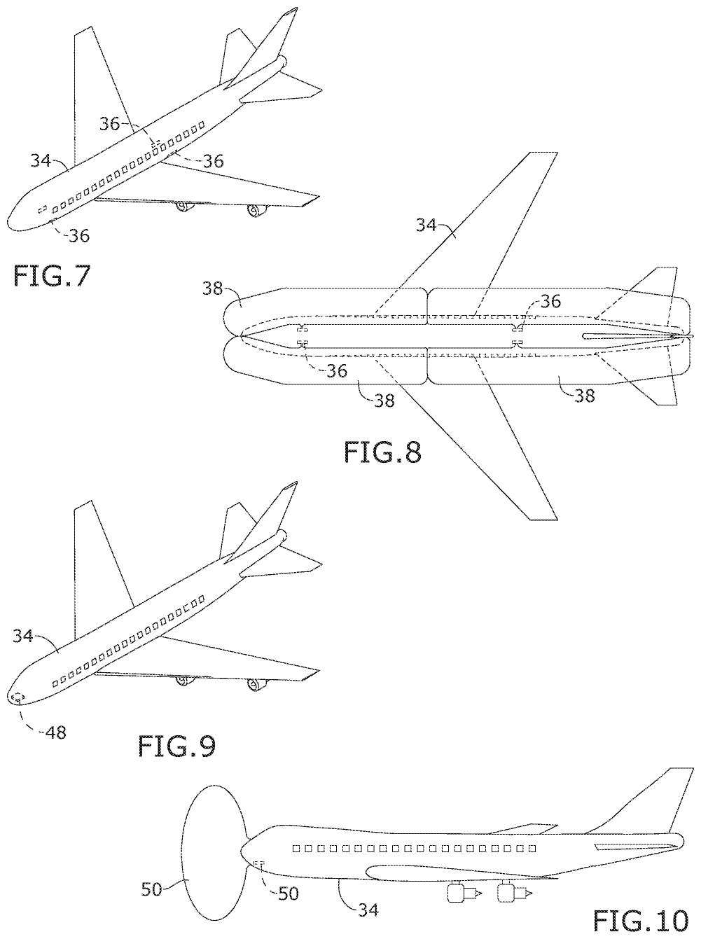

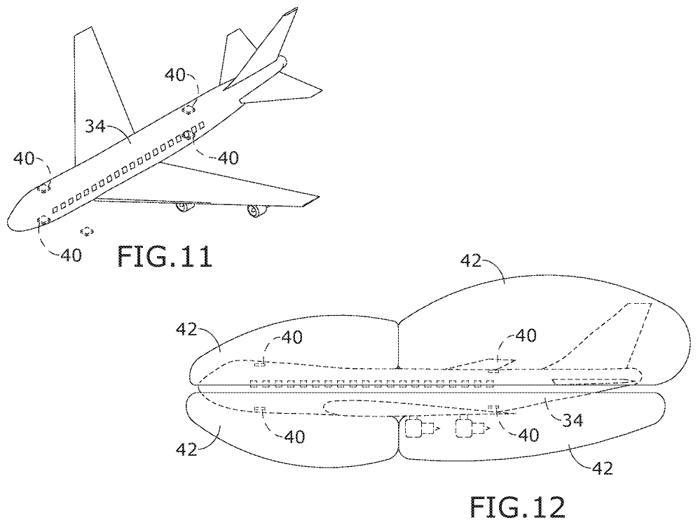

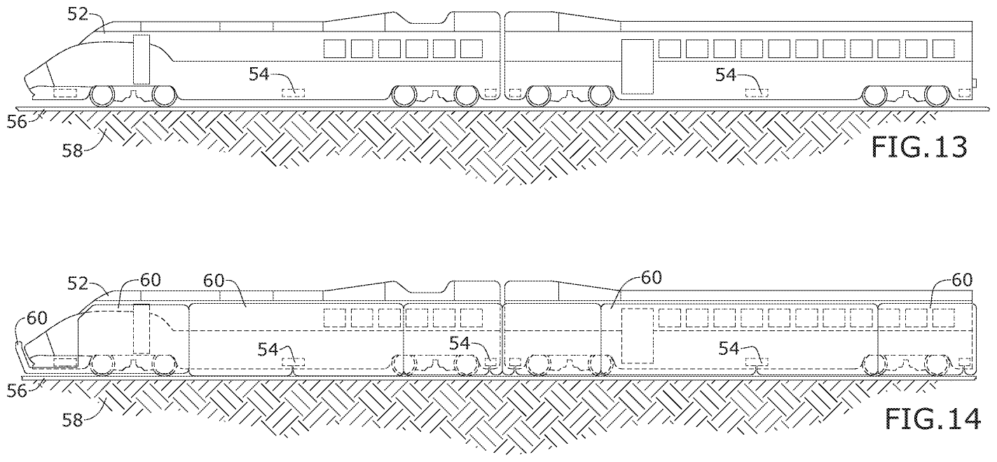

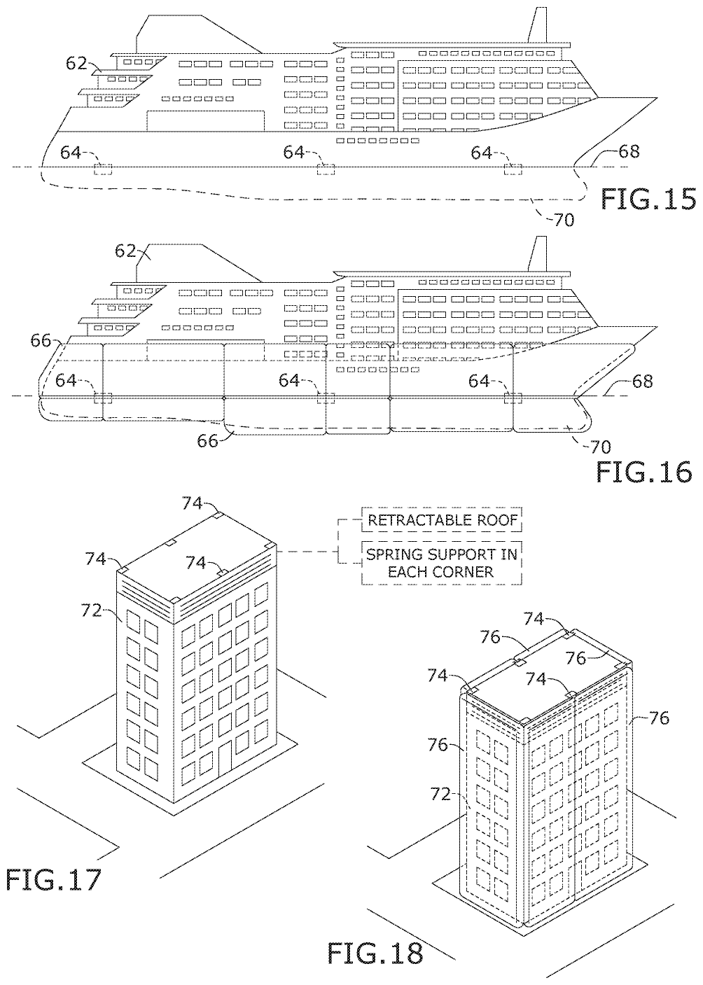

Referring to FIGS. 1 through 18, the present invention may include an external airbag safety system adapted to inflate externally around a vehicle 10, 18, 28, 34, 52, 62 or structure 72 to lessen the impact of a collision therewith.

The external airbag safety system embodies a plurality of stowable inflatable airbags 12, 20, 26, 36, 40, 44, 54, 48, 64 or 74 made from rubber, foam or similarly impact-absorbent material, etc., which are adapted to be inflated in a high-speed manner.

The stowable inflatable airbags 12, 20, 36, 54, 64 or 74 may be operatively associated with a chassis 14 of a car 10, a chassis 22 of a truck 18, a chassis 30 of a bus 28, various portions of a body of an aircraft 34 or train 52, a hull 70 of a watercraft 62, or the structural framing (e.g., the structural beams and columns) of a building 72. The stowable inflatable airbags 12, 20, 36, 54, 64 or 74, when not deployed are defined by a boundary that is mutually inclusive of the boundary of the associated vehicle 10, 18, 28, 34, 52, 62 or structure 72.

For the structure 72, the stowable inflatable airbags 74 may protrude from portions of the structure associated with mechanical equipment (e.g., HVAC equipment), such as along a roof top, but otherwise be mutually inclusive of the façade of the structure 72 along the sidewalls.

The stowable inflatable airbags 12, 20, 36, 54, 64 or 74 may be adapted and dimensioned to be selectively urged from a compact, deflated mutually-inclusive stowed condition (see the odd-numbered FIGS.) and an expanded, inflated, deployed condition (see the even-numbered FIGS. 16, 24, 32, 38, 42, 46, 50, 50, 60 and 66 that protrudes and extends beyond the boundaries of the vehicle 10, 18, 28, 34, 52, 62 or structure 72. In the case of the train 52, the deployed condition 60 may extend short of the train tracks 56 and/or the ground 58 supporting the train tracks 56. In the case of the watercraft 62, though, the deployed condition 66 may extend below the water line 68.

For the vehicles 10, 18, 28, 34, 52 and 62, the stowable inflatable airbags 12, 20, 36, 54, 64 may be disposed along the front, the sides and/or the rear thereof. The urging to the deployed condition may be triggered by sensors operatively associated with the vehicles 10, 18, 28, 34, 52 and 62, when and if the sensors detect a collision or imminent collision. The deployed condition 16, 24, 32, 38, 42, 46, 50, 50 60, 66 and 76 may be adapted to be drawn back into their stowed compartment with the push of a button after the crash.

A method of using the present invention may include the following. The external inflatable airbag safety system disclosed above may be provided. For transportation by aircraft 34, a user may use a U-shape (deployed condition) airbag 40 on the top and bottom of the aircraft 34 for conforming around the edges of curved boundary surfaces, and an oval shaped (deployed condition) inflatable airbag 40 in the front of the aircraft 34 to conform to the contours of the nose of the aircraft 34.

For transportation by water, a user may install the same type of U-shaped inflatable airbag 64 to match the shape of the watercraft's curved surfaces. The watercraft airbag 64 may be dimensioned to inflate just above the sea level 68 as well as below. Such inflatable airbags 64 are adapted to float and increase buoyancy of the watercraft 62. Likewise, the airbags in the deployed condition 16, 24, 32, 38, 42, 46, 50, 50, 60 and 66 for the other vehicles may also provide buoyancy to their respective vehicle if they crash into open water.

For transportation by ground, a user may install the stowed condition airbags 12, 20 and 26 that inflate in the shape of a large square airbag in the deployed condition 16, 24 and 32 in the front, the sides/under each vehicle door, and under the rear of the vehicle, and rectangular (deployed condition) airbags especially for buses 28 and trains 52. Trains 52 may derail unto their sides and so the airbags 60 should be predominantly along the entirety of the sides as well as the roof if it should turnover—the basic inflatable airbags 54 should be designed ready for any angle.

For buildings 72, the stowable inflatable airbags 74 may be in the ceilings of buildings to inflate around and in front of the lighting elements, etc. to stop people from ever having to go through something like the 9/11 attacks again. The walls of the structure 74 may also provide stowable inflatable airbags 74 matching shapes of the associated façade. Additionally, the stowable inflatable airbags 74 may be disposed in ceilings of the structures 72 so that if there was a collapse, lives would be spared.

It should be understood, of course, that the foregoing relates to exemplary embodiments of the invention and that modifications may be made without departing from the spirit and scope of the invention as set forth in the following claims.

What is claimed is:

1. An external airbag safety system for vehicles, comprising:
one or more stowable inflatable airbags movable between a stowed condition and a deployed condition;
each stowable inflatable airbag defined by a stowed boundary;
each stowable inflatable airbag attached to a vehicle so that the stowed boundary is mutually inclusive relative a vehicular boundary of the vehicle; and
the deployed condition comprises a rectangular deployed shape disposed beyond the vehicular boundary.

2. The external airbag safety system for vehicles of claim 1, further comprising:
one or more sensor operatively associated with each stowable inflatable airbags, wherein each sensor is configured to urge each stowable inflatable airbag to the deployed condition when sensing an imminent collision of the vehicle.

3. The external airbag safety system for vehicles of claim 1, wherein the vehicle is a motor vehicle.

4. The external airbag safety system for vehicles of claim 3, wherein a rectangular height of the rectangular deployed shape is approximately coextensive with a height of a portion the motor vehicle to which the stowable inflatable airbag is attached.

5. The external airbag safety system for vehicles of claim 1, wherein the vehicle is a train.

6. The external airbag safety system for vehicles of claim 5, wherein a rectangular height of the rectangular deployed shape is approximately coextensive with a height of a portion the train to which the stowable inflatable airbag is attached, and wherein a bottom of the rectangular deployed shape is dimensioned to be above a train track of the train.

7. The external airbag safety system for vehicles of claim 1, wherein the vehicle is an aircraft.

8. The external airbag safety system for vehicles of claim 7, wherein the deployed shape of the airplane extends beyond a vertical boundary defined by a vertical fin of the associated aircraft.

9. The external airbag safety system for vehicles of claim 8, wherein the deployed shape of the airplane extends from a nose of the associated aircraft.

10. The external airbag safety system for vehicles of claim 1, wherein the vehicle is a watercraft.

11. The external airbag safety system for vehicles of claim 10, wherein the deployed shape of the watercraft extends both above and below a water level of the associated watercraft.

12. The external airbag safety system for vehicles of claim 3, wherein each stowable inflatable airbag attached to a hull of the watercraft.

13. The external airbag safety system for vehicles of claim 3, wherein each stowable inflatable airbag attached to a chassis of the motor vehicle.

14. An external airbag safety system for a building structure, comprising:
one or more stowable inflatable airbags movable between a stowed condition and a deployed condition;
each stowable inflatable airbag defined by a stowed boundary;
each stowable inflatable airbag attached to a vehicle so that the stowed boundary is mutually inclusive relative a structural boundary of the building structure; and
the deployed condition comprises a deployed shape disposed beyond the structural boundary.

15. The external airbag safety system for a building structure of claim 14, further comprising:
a retractable roof of the building structure;
a spring support operatively associated with each corner of the retractable roof; and at least one of the one or more stowable inflatable airbag operatively associated with at least one corner of the retractable roof.
